(19) United States
(12) Patent Application Publication
(10) Pub. No.: US 2004/0139171 A1
(43) Pub. Date: Jul. 15, 2004

(54) Browser capable of regular expression-triggered advanced download of documents hyperlinked to current page

(76) Inventor: Richard C. Chen, Westmont, IL (US)

Correspondence Address: Richard C. Chen, 28 Tartan Lakes, Westmont, IL, 60559, US

(21) Appl. No.: 10/644,939

(22) Filed: Aug. 21, 2003

Related U.S. Application Data
(60) Provisional application No. 60/428,671, filed on Nov. 25, 2002.

(51) Int. Cl. G06F 15/16

(52) U.S. Cl. 709/218; 709/219

(57) ABSTRACT

In an information age, delivery speed is at a premium. Often this is at a greater financial cost. We introduce a method by which browser software can be made “smart” by preloading documents hyperlinked to the current page displayed by the browser. These documents are stored locally on the user's computer so that if requested, they will loaded directly from the local computer rather than from the remote server. This dramatically reduces document loading time to the point where time required for transfer across the internet is made null, and delivery is limited only by the computer's memory and CPU.

### CROSS-REFERENCE TO RELATED APPLICATIONS

This patent refers to claims made in the Provisional Patent Application No. 60/428,671, with filing receipt confirmation 1638. The Title is “Browser capable of Regular-Expression Triggered Advanced Download of documents linked to current page”

### BACKGROUND OF THE INVENTION

The speed with which hypertext documents on the world wide web can be downloaded onto a computer depends on a number of factors, including CPU power, memory capacity, and connection speed. The most important of these is connection speed, as this determines the amount of time it takes for the document to transfer from the server computer to the client computer. If the connection time were to be made null, such as the case if the document were already on the computer, this would trivialize the amount needed for a browser to open a document. We propose a means by which this speed can be increased greatly through a fundamental and deployable concept in browser design: the advanced download of documents hyperlinked to the document currently being displayed in the browser.

Current working models of browsers store any document currently being displayed in a temporary folder on the computer. Depending on the browser configuration, the hypertext document may or may not remain in this folder after the user leaves this page, whether by clicking on a hyperlink on it, or by typing another URL. If this document remains in the temporary folder, this would allow the browser to open it much faster (speeds less than a quarter of a second) should the same url be typed into the browser again. A new page, on the other hand, will need to be downloaded from a server computer in 2-5 seconds, depending on the factors mentioned above. A browser able to download in advance the documents hyperlinked to the current page that it displays, therefore, may increased the effective load time of these documents by at least a scale of ten.

The current means of triggering the download of a document is through a client side event in which the user uses a mouse and clicks on a hyperlink. This event sends a message to the server which responds by returning the document referred to in the hyperlink. File transfer between server computer and client computer is not triggered, therefore, until the user has read portions of a document and made a conscious decision to download another document hyperlinked to the current page. Such an event may not occur until minutes after the initial has been downloaded and displayed in the browser.

### BRIEF DESCRIPTION OF THE DRAWINGS

FIGS. 1 and 2 are textual and conceptual representations, respectively, of the means by which advanced download of hyperlinked documents can dramatically increase the effective waiting time for them.

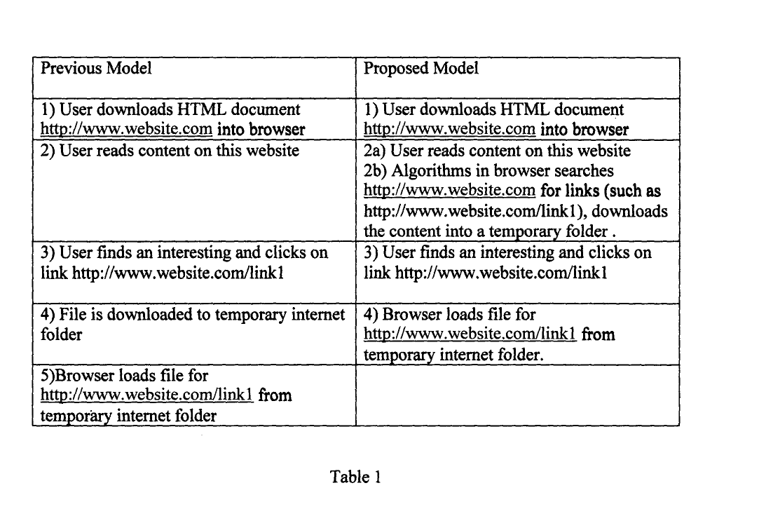

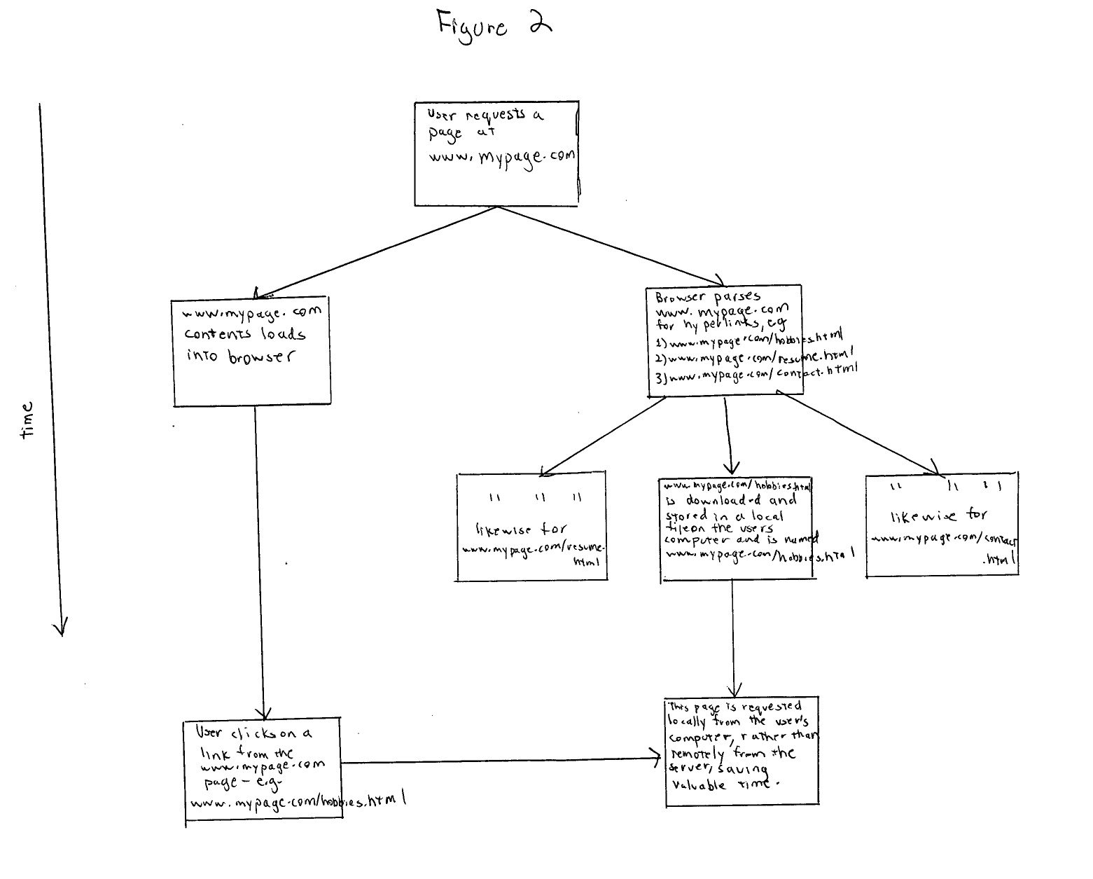

### DETAILED DESCRIPTION OF THE INVENTION

We propose a method which the browser can download in advance the documents hyperlinked to the current page through triggering by regular expressions. Rather than initiating file transfer through a user event (such as the mouse click), which can take a few seconds to a few minutes to occur after the current page is downloaded, this new browser is able to initiate file transfer of these other documents as soon as the current page is downloaded. These documents may be expressed on a side bar on the browser such that they are immediately accessible (e.g. already on the client computer) by the time the user clicks on hyperlinks to them. This is done through the means of algorithms containing regular expressions in the browser code.

A regular expression is a computer code construct that serves to locate text based on pattern matching. In every regular expression there are two functions: the matching function and the processing function. The matching function serves to find a string or strings of text based on pattern it contains. The processing function deals with the string or strings “found” by the matching function. Some examples include storing the string in a variable, deleting portions of the string, or replacing it with another string.

In our browser example we deal with the following functions: 1) A pattern match function called the lookahead and look behind assertion, in which the url hyperlink is identified by specifying the string immediately preceding it and following. Lookahead and lookbehind assertions are found in many languages, including:

| | Lookahead | lookbehind |
|---|---|---|
| GNU Egrep, Emacs, awk | \< | \> |
| Perl, PHP, Python | (?=\w) | (?<=) |
| Java | (?=\pL | (?<=\pL) |
| Tcl | \m | \M |

The symbols under lookahead column indicate the pattern immediately following to be the pattern directly preceding the expression sought, and the symbols under the lookbehind column indicate the pattern immediately preceding to directly follow the expression sought. In the case of the browser implementing this function the string sought would be of the form:

http://www.website.com

It might typically be encased within the string:

<a href=“http://www.website.com/”>Website</a></p

The lookahead pattern would therefore be:

<a href=”

and the lookbehind expression would therefore be

“>

2) Once a matching pattern is found, the url is stored as a string, and the download string function is called. (We understand the instance of calling a function to be standard concept in computer programming, whereby a command in one code will initiate a separate section of code to be “run.”) Many languages designed for “web scripting” support this feature. We provide two examples in Perl and PHP

```
                PHP:
<?php
$ch = curl_init (“http://www.example.com/”);
$fp = fopen (“example_homepage.txt”, “w”);
curl_setopt ($ch, CURLOPT_FILE, $fp);
curl_setopt ($ch, CURLOPT_HEADER, 0);
curl_exec ($ch);
curl_close ($ch);
fclose ($fp);
?>
                Perl
Use LWP::Simple
$html= get(‘http://www.example.com’);
open (OUT, “outfile.txt”);
print OUT “$html”;
while (<INFILE>)
```

In both examples, specific urls are mentioned. The url download function can also contain variable strings containing urls, which in the case of Perl and PHP are denoted by $. Specifically:

| Replace this | With this |
|---|---|
| $ch = curl_init | $url = ‘http://www.example.com’ |
| (“http://www.example.com/”); | $ch = curl_init (“$url”); |
| $html= | $url = ‘http://www.example.com’ |
| get(‘http://www.example.com’); | $html= get(‘$url’); |

We have also specified the instance by which the scripting languages write the downloaded content to a file, which may be at any location specified by the code:

Perl:

open (OUT, “outfile.txt”);

print OUT “$html”;

PHP:

$fp=fopen (“example_homepage.txt”, “w”);

curl_setopt ($ch, CURLOPT_FILE, $fp);

In the above examples cited, the first line opens the file (if no directory is specified, then the default directory is the one containing the program-as in this case) and names it. The second line writes the downloaded content to this file.

Implementation of Regular Expressions into Browser Code.

We outline the general procedures by which a browser written in any computer language can initiate advanced download of hyperlinked documents using regular expressions. We then use sample implementation of this software using the scripting language Perl.

1) An event handler that links a subroutine A to an event

a) Return key for a url in the location

b) mouseclick on a hyperlink in the browser window

2) Subroutine A runs

a) loads requested document from URL location bar into the browser window

b) uses regular expressions to parse for urls within the document in a)

c) downloads the hypertext for each url found in b)

d) stores the hypertext in local file on the computer, giving it the same name as the url

3) User clicks on a link in the browser window, triggering subroutine B

4) Subroutine B

a) extracts the url that was clicked on in step 3) and stores it as a string in a variable

b) looks for a hypertext file with this same name within the directory containing the documents downloaded in 2c)

We note here that the unique step is 4b). In the current model for browsers in use nowadays, step 4b) involves download of the said file from a remote server. This can take from 3 seconds to 5 minutes, depending on the size of the file. If the file is instead preloaded while the reader is reading the initial document loaded, it is readily accessible when the reader is clicks on any hyperlink of interest. The effective downloaded time is reduced to milliseconds.

### EXAMPLE

We implement each step listed above solutions using a programming language such as Perl

1a)

$locationbar→bind(‘<Return>’, [$w,‘url’,Tk::Ev([‘get’])]);

In step 1a) the pressing down of the return or enter key is bound (by the ‘bind’ function) to the location bar object. The url variable stores the URL typed in the location bar, and is the argument to the TK::Ev[‘get’] module, which downloads the hypertext associated with it.

1b)

$w→tagBind($tag,‘<Button-1>’, [$w,‘HREF’,$href,‘GET’]);

This analogous to step 1a). Whereas in 1a) the activating event was the pressing down of the return key, here it is the mouse click. In 1a) the object linked to the event is the url location bar. Here, the object is any hyperlink object displayed in the browser window.

In the code above $href represents the hyperlink object, and HREF is the subroutine that downloads the url associated with the hyperlink object.

2a) subroutine href

2b 2c and 2d)

```
open (localurl, “>$url”)∥print “can't open file $url”;
print localurl $html;
close (localurl);
open (localurl, “$url”)∥print “can't open file $url”;
while (<localurl>)
{
if (/href/)
{
$count++;
# use regular expressions to parse for hyperlinks within the initially
  loaded document
$_=˜/(?<=href).*(?=”>)/gis;
# store the url in an array
@parseurl[$count]= $&;
$urlname= @parseurl[$count];
# now open a file by the same name and download it- remembering
  to apply the same rules as above
$temp = $parseurl[$count];
# form a unique file handle for each url file to be opened
FILEHANDLE=url.$count;
open (FILEHANDLE, “>$urlname”)∥print “can't open $urlname”;
$html = get ($temp);
print FILEHANDLE $html;
}
```

For step 2b) we download the initial page requested by the browser and store all the hypertext within, a single string, $html. We open a file using the url of this document (filehandle localurl), $url, and print the string $html to this file. We close this file, then reopening it for reading. We then apply regular expressions to search for hyperlinks within this document. We then move on to 2c) and 2d), storing each hyperlink into the array @parseurl, and, for each element this array, downloading the hypertext ($temp), and then opening a separate using the url name, and then printing the hypertext to that file

4a)

$urlfile=$url;

Here we retrieve the url string, $url, from the hyperlink object in 1b)

4b)

### open the file for a “local” download
open (localurl, “>$urlfile”)∥print “can't open file $urlfile”;
while (<localurl>)
{
#print directly into browser window
$browserwindow->insert(“end”, $_);
}

Once triggered by the event in 3) the program then looks for a file with name $urlfile, opens it, and then prints the file line by line to the browser window.

We summarize the steps of the current and proposed model in Table 1

1) A browser or a software program which downloads web pages and displays them to a user (hereby “browser”) capable of regular-expression-triggered download of hyperlinks found within the hypertext markup language obtained by means of the initial hypertext transfer protocol (“http”) request of the Uniform Resource Locator (“url”)from a remote web server, typically entered at location bar near the top of the graphical user interface of the browser. This is often instigated by
a) Key down action of the Enter or return key
b) Button click of an adjacent “submit” button

2) A browser capable of storing the subsequent hypertext mentioned in claim 1 into local files into the computer

3) The method of claim 2 in which the code module responsible for linking the client side event of 1a) and 1b) is able to
3a) download the hypertext found at the Uniform Resource Locator in 1)
3b) store the hypertext in a file
3c) parse the file in 3b) for hyperlinks through the use of regular expressions
3d) download the hypertext associated with the hyperlinks extracted in 3c

4) A software program capable of naming the files mentioned in claim 2 using the hyperlinks associated with them.

5) A software program capable of loading into the display window hypertext associated with a given hyperlink by means of loading it directly from the local file mentioned in claim 2 by searching through the directory for a file with the name mentioned in claim 4

6) The method of claim 5, whereby the module responsible for linking the mouseclick event on a hyperlink object in the display window is able to
a) store the Uniform Resource Locator associated with the hyperlink into a string
b) search through the directory on the local computer with the file name matching the string mentioned in 6b
c) loading the contents of this file into the browser window
